(19) United States
(12) Patent Application Publication
(10) Pub. No.: US 2005/0018282 A1
(43) Pub. Date: Jan. 27, 2005

(54) Confocal scanning microscope

(75) Inventor: Juergen Riedmann, Harthausen (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Leica Microsystems Heidelberg GmbH, Mannheim (DE)

(21) Appl. No.: 10/892,580

(22) Filed: Jul. 16, 2004

(30) Foreign Application Priority Data
Jul. 23, 2003 (DE) DE 103 33 445.9

(51) Int. Cl. G02B 21/06

(52) U.S. Cl. 359/385; 359/368

(57) ABSTRACT

A confocal scanning microscope for scanning a sample has an illumination beam path that encompasses at least one point light source and a beam deflection device, and has further a detection beam path that encompasses at least one detection pinhole and the beam deflection device. The routing of the illumination beam path and/or of the detection beam path is adaptable to the scanning speed.

### CROSS REFERENCE TO RELATED APPLICATIONS

This application claims priority to German patent application 103 33 445, the subject matter of which is hereby incorporated by reference herein.

### FIELD OF THE INVENTION

The invention concerns a confocal scanning microscope for scanning a sample.

### BACKGROUND OF THE INVENTION

In scanning microscopy, a sample is illuminated with a light beam in order to observe the reflected or fluorescent light emitted from the sample. The focus of an illuminating light beam is moved in a specimen plane by means of a controllable beam deflection device, generally by tilting two mirrors, the deflection axes usually being perpendicular to one another so that one mirror deflects in the X direction and the other in the Y direction. Tilting of the mirrors is brought about, for example, by means of galvanometer positioning elements. The power level of the light coming from the specimen is measured as a function of the position of the scanning beam. The positioning elements are usually equipped with sensors to ascertain the present mirror position.

In confocal scanning microscopy specifically, a specimen is scanned in three dimensions with the focus of a light beam. A confocal scanning microscope generally comprises a light source, a focusing optical system with which the light of the source is focused onto an aperture (called the “excitation pinhole”), a beam splitter, a beam deflection device for beam control, a microscope optical system, a detection pinhole, and the detectors for detecting the detected or fluorescent light. The illuminating light is coupled in, for example, via a beam splitter. The fluorescent or reflected light coming from the specimen travels back through the beam deflection device to the beam splitter, passes through it, and is then focused onto the detection pinhole behind which the detectors are located. Detected light that does not derive directly from the focus region takes a different light path and does not pass through the detection pinhole, so that a point datum is obtained which results, by sequential scanning of the specimen, in a three-dimensional image.

The path of the scanning light beam on or in the specimen ideally describes a meander (scanning one line in the X direction at a constant Y position, then stopping the X scan and slewing by Y displacement to the next line to be scanned, then scanning that line in the negative X direction at constant Y position, etc.). As the scanning speed increases, the scanning track deviates more and more from the meander shape. This phenomenon is attributable substantially to the inertia of the moving elements. With fast scanning, the scanning track looks more like a sine curve, although it often happens that the trajectory portion upon scanning in the positive X direction differs from the trajectory portion upon scanning in the negative X direction.

A three-dimensional image is usually achieved by acquiring image data in layers, the path of the scanning light beam on or in the specimen ideally describing a meander (scanning one line in the X direction at a constant Y position, then stopping the X scan and slewing by Y displacement to the next line to be scanned, then scanning that line in the negative X direction at constant Y position, etc.). To make possible acquisition of image data in layers, the sample stage or the objective is shifted after a layer is scanned, and the next layer to be scanned is thus brought into the focal plane of the objective.

In many scanning microscopes, the beam deflection device contains so-called galvanometer mirrors, or resonant galvanometer mirrors in order to achieve higher scanning rates. U.S. Pat. No. 6,449,039 BI discloses a laser scanning microscope in which an acoustooptical deflector (AOD) is provided as the beam deflection device. While line scan frequencies of several hundred Hz to several kHz are achievable with galvanometer mirrors, line scan frequencies of several tens of kHz are attained with acoustooptical beam deflection devices. German Unexamined Application DE 100 38 622 A1 discloses a scanning microscope having micromirrors. Because micromirrors have little mass to be moved, a very high scanning rate is possible with this scanning microscope.

### SUMMARY OF THE INVENTION

It has been found that the detection efficiency of the known scanning microscopes disadvantageously decreases at high and very high scanning rates. It is therefore an object of the present invention to provide a scanning microscope in which the detection efficiency is substantially independent of the scanning rate.

The present invention provides a confocal scanning microscope comprising: at least one point light source and a beam deflection device both defining an illumination beam path, a detection beam path defined by at least one detection pinhole and the beam deflection device, wherein the routing of the illumination beam path and/or of the detection beam path is adaptable to a scanning speed of the beam deflection device.

What has been recognized according to the present invention is that at high scanning rates, the change in the deflection angle of the beam deflection device during the transit time of an illuminating light photon from the beam deflection device to the sample, the time until emission of a fluorescence photon, and the transit time of that fluorescence photon to the beam deflection device, must not be ignored. During that time, the position of the continuously oscillating beam deflection device changes in such a way that only a portion of the detected light—and in extreme cases none at all—strikes the detection pinhole that is correctly adjusted for low scanning rates. For example, at a scanning rate of 80 kHz and with a maximum deflection angle of 8 degrees for the beam deflection device, with a light travel path of 50 cm between the beam deflection device and the sample, and assuming 10 ns for the time between excitation of a fluorescent dye and emission of a fluorescence photon (average lifetime of the excited state), a detected light beam strikes the plane of the detection pinhole with an offset of 8.9 μm. In this example, the time span between emergence of an illuminating light photon from the beam deflection device and arrival of a fluorescence photon (detected light photon) is 13.3 ns. During that time, the deflection angle of the beam deflection device changes by 0.017 degree. In existing scanning microscopes, a displacement of 8.9 μm corresponds to approximately half of the smallest detection pinhole diameter that can be set, i.e. approximately 10% of the diameter of an Airy disk for presently available objectives. The loss of detection light is correspondingly dramatic.

The confocal scanning microscope according to the present invention has the advantage that the routing of the illuminating beam path and/or of the detection beam path is adaptable to the scanning speed in such a way that essentially all of the detected light proceeding from the scan points being scanned strikes the detection pinhole.

In a preferred embodiment, the point light source is defined by an illumination pinhole illuminated from behind. In another advantageous variant, a laser or a system of lasers serves as the point light source. As a rule, an illumination pinhole can be dispensed with when lasers are used, since the lasers usually have a focus within the resonator and can thus serve as a point light source.

In a variant embodiment, the routing of the illumination beam path and/or of the detection beam path is permanently settable to a specific scanning speed. In this variant, the scanning microscope operates with optimum detection efficiency only at the specific scanning speed. This is entirely sufficient for many applications, however. With this variant, the point light source or illumination pinhole, and the detection pinhole, are arranged in stationary fashion at positions matched to the specific scanning speed.

In a preferred variant embodiment, the point light source (illumination pinhole) and/or the detection pinhole are arranged displaceably. A displacement apparatus that displaces the point light source and/or the detection pinhole as a function of the scanning speed is preferably provided for this purpose. A variant in which the displacement is accomplished automatically is very particularly advantageous. The displacement apparatus advantageously comprises a motorized drive system for this purpose. That drive system can be embodied, for example, as a galvanometer drive system or preferably as a fast piezo drive system.

In a preferred variant, the displacement apparatus displaces the point light source and/or the detection pinhole synchronously with the scanning operation, by which means it is possible to account for the fact that the scanning track along which the illuminating light beam is guided over or through the sample is traversed at different scanning speeds. As a rule, the scanning track is similar to a sine curve, the reversing points being traversed at a lower scanning speed than the largely linear portions of the scanning track. This variant is very particularly advantageous because the routings of the illuminating beam path and of the detection beam path are always optimally adjusted to the current scanning speed. For many applications, however, it will be sufficient if adaptation to an average scanning speed is accomplished.

In another variant embodiment, a beam guidance element is provided for adapting the routing of the illuminating beam path or the detection beam path to the scanning speed. The beam guidance element can contain, for example, a mirror, a lens, an acoustooptical component, an electrooptical component, a glass plate, or a grating. The arrangement and/or position of the beam guidance element is preferably modifiable as a function of the scanning speed. A variant in which the arrangement and/or position of the beam guidance element is automatically modifiable as a function of the scanning speed is very particularly preferred.

Provision can also be made for the arrangement and/or position of the beam guidance element to be modified synchronously with the scanning operation in order, as already described, to achieve an adaptation of the routing of the illumination beam path and the detection beam path to the scanning speed that changes as the scanning track is traversed.

An adjusting apparatus that brings about the modification of the arrangement and/or position of the beam guidance element is preferably provided. The adjusting apparatus preferably has a motorized drive system.

### BRIEF DESCRIPTION OF THE DRAWINGS

The subject matter of the invention is depicted schematically in the drawings and will be described below with reference to the Figures, identical or identically functioning elements being labeled with the same reference characters. In the drawings:

FIG. 1 shows a scanning microscope according to the present invention;

FIG. 2 is a detail view of a scanning microscope according to the present invention; and

FIG. 3 is a detail view of another scanning microscope according to the present invention.

### DETAILED DESCRIPTION OF THE INVENTION

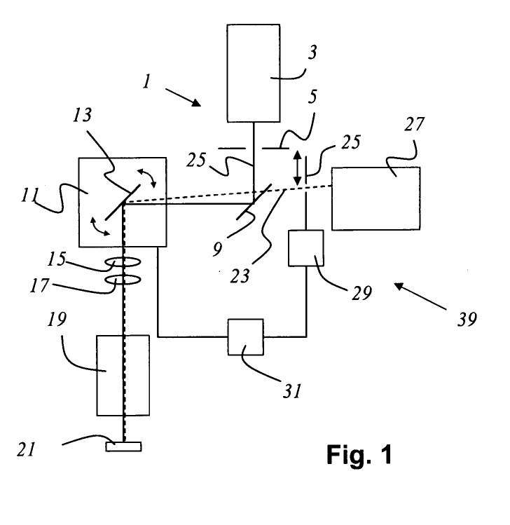

FIG. 1 shows a confocal scanning microscope according to the present invention, having a point light source 1 that comprises a laser 3 which illuminates an illumination pinhole 5. Light beam 7 passing through illumination pinhole 5 is directed by a main beam splitter 9 to a beam deflection device 11 that contains a gimbal-mounted scanning mirror 13. Beam deflection device 11 guides illuminating light beam 7, through scanning optical system 15, tube optical system 17, and objective 19, over or through sample 21. An illumination beam path is defined by point light source 1, main beam splitter 9, beam deflection device 11, and the aforesaid downstream optical systems. Detected light 23 proceeding from the sample travels through objective 19, tube optical system 17, and scanning optical system 15 and via beam deflection device 11 back to main beam splitter 9, passes through the latter, and then strikes detection pinhole 25. Detected light passing through detection pinhole 25 is detected by a detector 27. The detector generates electrical signals, proportional to the power level of the detected light, that are conveyed to a processing unit (not shown). Detection pinhole 25, beam deflection device 11, and the optical systems arranged between beam deflection device 11 and sample 21 define a detection beam path whose routing is adaptable to the scanning speed by displacement of detection pinhole 25. A displacement apparatus 27 that contains a motorized piezo drive system 29 is provided for displacement of detection pinhole 25. Displacement apparatus 39 is controlled by a control device 31 that receives from the beam deflection device signals regarding the position of scanning mirror 13. This makes it possible to adapt the position of detection pinhole 25 to the respective actual scanning speed as the scanning track is traversed. In this context, detection pinhole 25 executes an oscillating motion along displacement direction 39. For certain applications, it may be sufficient to adapt the position of detection pinhole 25 to the average scanning speed, so that the position of detection pinhole 25 remains constant during scanning.

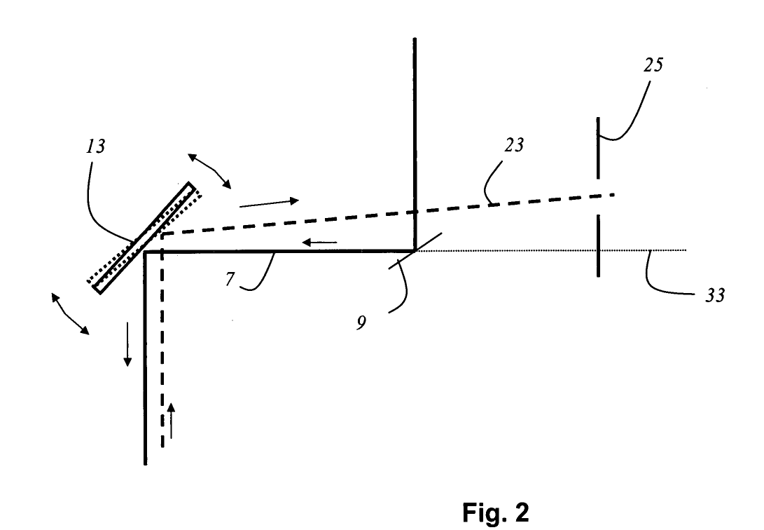

FIG. 2 is a detail view of a scanning microscope according to the present invention. The Figure illustrates graphically that because of the transit-time effects between the scanning mirror and sample, and possibly also because of the delayed emission of fluorescence photons in the case of fluorescent dyes, detected light 23, after passing scanning mirror 13, is not located on the same optical axis 33 as illuminating light beam. For adaptation of the detection beam path, detection pinhole 25 is arranged laterally offset with respect to optical axis 33, so that the effect described above is advantageously compensated for.

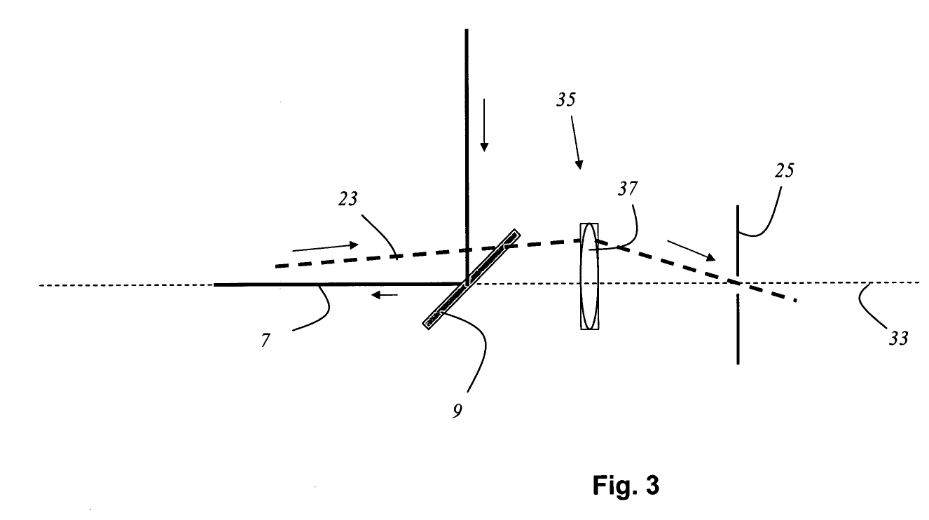

FIG. 3 is a detail view of another scanning microscope according to the present invention. In this scanning microscope, what is provided for adapting the routing of the detection beam path to the scanning speed is a beam guidance element 35 containing a lens 37 that directs detected light 23, which is proceeding away from optical axis 33 as a result of the effect described above, to detection pinhole 25 that is arranged on optical axis 33.

The invention has been described with reference to a particular exemplary embodiment. It is self-evident, however, that changes and modifications can be made without thereby leaving the range of protection of the claims below.

1. A confocal scanning microscope for scanning a sample comprising:
at least one point light source and a beam deflection device both defining an illumination beam path, a detection beam path defined by at least one detection pinhole and the beam deflection device, wherein the routing of the illumination beam path and/or of the detection beam path is adaptable to a scanning speed of the beam deflection device.

2. The confocal scanning microscope as defined in claim 1, wherein the point light source comprises an illumination pinhole.

3. The confocal scanning microscope as defined in claim 1, wherein the routing of the illumination beam path and/or of the detection beam path is permanently settable to a specific scanning speed.

4. The confocal scanning microscope as defined in claim 3, wherein the point light source and the detection pinhole are arranged in stationary fashion at positions matched to a specific scanning speed.

5. The confocal scanning microscope as defined in claim 1, wherein the point light source and/or the detection pinhole are arranged displaceably.

6. The confocal scanning microscope as defined in claim 5, wherein a displacement apparatus is provided that displaces the point light source and/or the detection pinhole as a function of the scanning speed.

7. The confocal scanning microscope as defined in claim 6, wherein the displacement apparatus automatically displaces the point light source and/or the detection pinhole as a function of the scanning speed.

8. The confocal scanning microscope as defined in claim 6, wherein the displacement apparatus contains a motorized drive system.

9. The confocal scanning microscope as defined in claim 7, wherein the displacement apparatus contains a motorized drive system.

10. The confocal scanning microscope as defined in claim 5, wherein the displacement apparatus displaces the point light source and/or the detection pinhole synchronously with the beam deflection device.

11. The confocal scanning microscope as defined in claim 1 further comprising a beam guidance element for adapting the routing of the illuminating beam path and/or of the detection beam path to the scanning speed.

12. The confocal scanning microscope as defined in claim 11, wherein the beam guidance element comprises a mirror and/or a lens and/or an acoustooptical component and/or a glass plate and/or an electrooptical component and/or a grating.

13. The confocal scanning microscope as defined in claim 11, wherein the arrangement and/or position of the beam guidance element is modifiable as a function of the scanning speed.

14. The confocal scanning microscope as defined in claim 13, wherein the arrangement of the beam guidance element is automatically modifiable as a function of the scanning speed.

15. The confocal scanning microscope as defined in claim 13, wherein the arrangement and/or position of the beam guidance element is modifiable synchronously with the beam deflection device.

16. The confocal scanning microscope as defined in claim 11 further comprising an adjusting apparatus that brings about the modification of the arrangement and/or position of the beam guidance element.

17. The confocal scanning microscope as defined in claim 16, wherein the adjusting apparatus contains a motorized drive system.
